(19) United States
(12) Patent Application Publication
(10) Pub. No.: US 2024/0372343 A1
(43) Pub. Date: Nov. 7, 2024

(54) FACILITY ARRANGEMENT AND METHOD FOR CONNECTING TWO OR MORE FACILITIES

(71) Applicant: Siemens Gamesa Renewable Energy A/S, Brande (DK)

(72) Inventor: Johnny Soerensen, Videbaek (DK)

(21) Appl. No.: 18/686,561

(22) PCT Filed: Aug. 31, 2022
(86) PCT No.: PCT/EP2022/074161

§ 371 Date: Feb. 26, 2024

(30) Foreign Application Priority Data
Sep. 8, 2021 (EP) 21195538.0

(51) Int. Cl. H02G 1/10; H02G 9/12

(52) U.S. Cl. CPC H02G 1/10; H02G 9/12

(57) ABSTRACT

A facility arrangement is provided including facilities and at least one connector connected to the facilities, wherein the connector includes a transporter, at least one buoyancy device and/or at least one weight device, wherein the transporter is adapted for transportation of electricity and/or a fluid medium, wherein the buoyancy device and/or the weight device are attached to the transporter, wherein the connector is between two offshore facilities, wherein the transporter is floating at a distance from the seabed over the entire or almost the entire distance between the facilities, and/or wherein the buoyancy device and/or the weight device are attached to a first section of the transporter, wherein the first section is connected to at least one offshore facility and floating at a distance from the seabed, wherein a second section of the transporter connected to the first section and an onshore facility is embedded in the seabed.

### CROSS-REFERENCE TO RELATED APPLICATIONS

This application claims priority to PCT Application No. PCT/EP2022/074161, having a filing date of Aug. 31, 2022, which claims priority to EP Application No. 21195538.0, having a filing date of Sep. 8, 2021, the entire contents both of which are hereby incorporated by reference.

### FIELD OF TECHNOLOGY

The following relates to a facility arrangement comprising two or more facilities and at least one connection means or connector connected to the facilities, wherein the connection means or connector comprises a transportion means or transporter, at least one buoyancy means or buoyancy device and/or at least one weight means or weight device, wherein the transportion means or transporter is adapted for transportation of electricity and/or a fluid medium, wherein the buoyancy means and/or the weight means or weight device are attached to the transportion means or transporter. Furthermore, the following relates to a method for connecting two or more facilities with at least one connector means or connector.

### BACKGROUND

Wind parks and other arrangements of offshore facilities may require connection means that connect the individual facilities like the wind turbines to each other and also to further facilities like offshore substations and/or onshore facilities. In areas with deeper water, in which floating facilities like floating wind turbines are installed, an electrical connection may be established for instance by using dynamic cables with a high flexibility, which are able to withstand water movement like tidal movement, water currents and/or wave influence. Furthermore, also the movement of the wind turbines mounted on floating foundations may act on the dynamic cable so that it has to exhibit also a sufficient flexibility for withstanding the movements of the wind turbine foundations.

For connecting the wind turbines, it is known to arrange the cable between the wind turbines in or on the seabed and to connect its ends more or less vertically to the floating wind turbines. Therefore, the length of the cable has to bridge the distance between the wind turbines and two times the depth of the water. This requires comparatively long cables, in particular in regions with deep water. In addition, the need for a flexible cable, which is able to withstand the movement of the water and the connected facilities, requires the use of comparatively expensive cables.

As an alternative to the arrangement of the cable directly on the seabed, also a sub-sea connector may be used. However, the installation of a sub-sea connector on the seabed may be expensive, in particular in areas with deep water.

In WO 2019/158431 A1, an offshore arrangement with a connecting device is disclosed. The offshore arrangement comprises two substations, which are connected by a cable. The substations are connected to two connecting devices, which are arranged in the sea, and which allow for connecting flexible cables between the connecting device and substations and to use a more rigid cable as an intermediate cable connecting the connecting devices.

### SUMMARY

An aspect relates to a facility arrangement with an improved connection between two or more facilities.

According to embodiments of the invention, this problem is solved by a facility arrangement as initially described,
wherein the connection means or connector is arranged between two offshore facilities, wherein the transportion means or transporter is floating at a distance from the seabed over the entire or almost the entire distance between the facilities, and/or
wherein the buoyancy means and/or the weight means or weight device are attached to a first section of the transportion means or transporter, wherein the first section is connected to at least one offshore facility and arranged floating at a distance from the seabed, wherein a second section of the transportion means or transporter connected to the first section and an onshore facility is embedded in the seabed.

The facility arrangement may comprise one or more offshore facilities and/or one or more onshore facilities, which are connected using one or more connection means or connector. The connection means or connector may be used in particular for connecting two facilities. The connection means or connector comprises a transportion means or transporter, at least one buoyancy means and/or at least one weight means or weight device. By using the buoyancy means and/or the weight means or weight device, an updrift, or a drown drag, respectively, may be applied to the transportion means or transporter when it is arranged in the water.

For connecting two offshore facilities, the connection means or connector is arranged floating at a distance from the seabed over the entire or almost the entire distance between the facilities. In particular, the transportion means or transporter is arranged in a distance from the seabed over the entire distance between the facilities. The transportion means or transporter is floating in the water over the entire distance or almost the entire distance. Almost the entire distance means in this context that the transportion means or transporter may be arranged at least partly above the sea surface in connection sections at the immediate proximity of the facilities, depending on the location of the connection to the transportion means or transporter at the facility.

By using the buoyancy means or buoyancy device and/or the weight means or weight device, the density of the connection means or connector may be adjusted to a certain water depth so that the transportion means or transporter is floating at a distance from the seabed over the entire or almost the entire distance between the facilities. The buoyancy means and the weight means or weight device may also be used to arrange the transportion means or transporter relative to the sea surface, or the seabed, respectively. In particular, the transportion means or transporter is also floating at a distance from the water surface over the entire distance or almost the entire distance between the facilities so that vessels may pass by above the transportion means or transporter.

Due to its arrangement, the floating transportion means or transporter has a shorter length than a cable or a pipe which is arranged partly on or in the seabed since the distance between the facility and the seabed does not have to be bridged twice. This reduces the costs for fabrication and installation of the connection means or connector.

Furthermore, the buoyancy means and/or the weight means or weight device, which are attached to the transportion means or transporter, allows for the usage of transportion means or transporter with a reduced flexibility. The usage of the buoyancy means and/or the weight means or weight device allows for stabilizing the floating arrangement of the transportion means or transporter and/or the position of the transportion means or transporter a certain depth, or within a target depth range, respectively, reducing the forces and loads acting on the transportion means or transporter.

In particular, it is possible to use a static transportion means or transporter which is originally designed for an arrangement in or on the seabed for connecting the facilities. Since less water-induced forces and loads are acting on cables or pipes that are arranged in or on the seabed, static cables or pipes that are less flexible can be used for this purpose. Due to the reduced flexibility requirements, static transportion means or transporter are generally cheaper than the more flexible dynamic transportion means or transporter. The floating arrangement of the transportion means or transporter using the buoyancy means and/or the weight means or weight device enables the usage of more cost-efficient static transportion means or transporter also in an arrangement above the seabed.

The one or more buoyancy means may be used for instance with a heavy transportion means or transporter, for instance with an electrical cable. Heavy means in this context that the density of the transportion means or transporter exceeds the density of water so that the transportion means or transporter experiences an initial down drag when arranged in the water. By the buoyancy means, the density of the connection arrangement may be lowered so that the floating arrangement of the transportion means or transporter becomes possible. The weight means or weight device may be used together with a transportion means or transporter that has a density lower than water, for instance a gas transportation pipe or the like. By the weight means or weight device, the density of the connection arrangement may be increased so that the floating arrangement of the transportion means or transporter above the seabed and in particular also below the water surface becomes possible.

In addition, also both buoyancy means and weight means or weight device may be attached to the transportion means or transporter in order to adjust a density of the connection means or connector, for instance to keep the density of the connection arrangement within a certain range for filled, unfilled and/or differently filled hollow transportion means or transporter like gas pipes.

The facility arrangements have the advantage that the connection means or connector is easy to install and that no seabed interfaces are required for connecting two offshore facilities. Furthermore, the connection means or connector can be realized with a reduced need for material and therefore cost-efficient. Since no structures, which have to be installed on the seabed are required, the installation process and repair procedures are relatively easy.

For connecting an offshore facility to an onshore facility, a first section of the transportion means or transporter is connected to the offshore facility. The first section is arranged floating at a distance from the seabed. In particular, the first section is also arranged at a distance below the sea surface. The second section of the transportion means or transporter, which is directly connected to the first section of the transportion means or transporter, is embedded in the seabed and connected to an onshore facility at one end.

This allows for using a floating arrangement of the first section of the transportion means or transporter in the areas with deep water. To the first section, one or more buoyancy means and/or one or more weight means or weight device are attached as previously described. In areas with lower water, the second section of the transportion means or transporter may be embedded in the seabed. Compared to an arrangement of the transportion means or transporter embedded in the seabed or the entire distance, a reduced length of the transportion means or transporter is obtained, in particular due to the floating arrangement of the first section of the transportion means or transporter.

Depending on the position of the offshore facilities relative to the coast, the length of the second section may be between hundreds of meters and tens of kilometers. Also, the distances in between two offshore facilities and/or the length of the first section of the cable may be between hundreds of meters and tens of kilometers.

In an embodiment, the transportion means or transporter comprises at least one electrical cable, at least one optical cable and/or at least one pipe for gas transport. The electrical cable may be an AC-cable or a DC-cable, in particular for a high-power energy transport of electrical energy generated by a wind turbine. It is also possible to provide at least one electrical cable and/or at least one optical cable which is used for communication between the facilities and/or further communication devices.

The transportion means or transporter may also comprise at least one pipe for gas transport, for instance a gas pipe for the transport of hydrogen, methane, ammonia and/or another type of gas. The gas pipe, or tube, respectively, may consist for instance of a plastic material like high density polyethylene (HDPE).

In particular, the transportion means or transporter may comprise a plurality of electrical cables, a plurality of optical cables and/or a plurality of pipes for gas transport. The transportion means or transporter may be a bundle of cables and/or pipes. It is also possible that the transportion means or transporter comprises at least one cable, which is arranged inside an outer shell, in particular inside a tube, or a pipe, respectively, for the transportation of both gas and electrical energy. In addition, or alternative, the outer shell may be a protective shell for protecting the cable form environmental influences.

Depending on the composition of the transportion means or transporter, one or more buoyancy means and/or one or more weight means or weight device may be used to create updrift, and/or down drag, respectively, to the transportion means or transporter. In particular, when pipes for gas transport, which tend to flow when they are filled with gas during operation, are used, weight means or weight device may be attached to keep the transportion means or transporter within a target depth, or depth range, respectively, especially to avoid floating of the transportion means or transporter at the water surface.

The density of the buoyancy means and/or the weight means or weight device may be chosen in such manner, that the density of the connection arrangement, hence the density of the combination of the transportion means or transporter and the buoyancy means and other weight means or weight device, is approximately equal to the water density in the depth, in which the transportion means or transporter should be arranged in the water. It is also possible that the density is chosen in such manner that it is slightly below the density of the water in the target depth so that a small force directed downwards to the seabed is acting on the transport arrangement.

In an embodiment, the connection means or connector is connected to a floating foundation, in particular a floating foundation moored to the seabed, of the offshore facility or the offshore facilities. The movement of the floating foundation of the offshore facility is usually limited, for instance when the floating foundation is moored to the seabed. Due to the limited movement of the floating foundation, also the movement of the connection means, or of the transportation the connection means or connector, respectively, is limited. This reduces the loads and forces which has to be taken by the transportion means or transporter. The connection means or connector and the floating arrangement of the transportion means or transporter, are the first section of the transportion means or transporter, respectively, may be used with any type of floating foundations.

In an embodiment, the transportion means or transporter is arranged below the sea surface, in particular in a depth of ten meters or more. The arrangement of the transportion means or transporter below the sea surface allows that a vessel may pass above the transportion means or transporter and therefore also in between the two facilities connected by the connection means or connector. A contact between the transportion means or transporter and a vessel, in particular the propeller of a vessel, may be avoided if the transportion means or transporter is arranged below the sea surface, for instance in a depth of ten meters or below.

In connecting regions, in which the transportion means or transporter is connected to an offshore facility, a lower depth of the transportion means or transporter and/or an arrangement of a section of the transportion means or transporter at the sea surface may be chosen may be chosen, depending on the position of the connecting interface between the transportion means or transporter and the facility. However, in this case the majority of the length of the transportion means or transporter, or its first section, is arranged below the sea surface. In particular, more than 90% or more than 95% of the length of the transportion means or transporter, or its first section, are arranged below the sea surface in a target depth, in particular in a depth of ten meters or more.

The target depth of the transportion means or transporter may also be a depth range, for instance a depth range between ten meters and 40 meters, or between 15 meters and 50 meters. However, also a larger depth, or a larger distance below the water level, may be chosen depending on the side conditions, for instance when strong currents are present at a certain water depth. By adjusting the depth of the transportion means or transporter in the water by using the buoyancy means and/or the weight means or weight device, an arrangement of the transportion means or transporter in areas with high currents and/or with the risk of being damaged due to vessel traffic may be avoided.

In an embodiment, the second section of the transportion means or transporter is embedded in a coastal region, in particular in a region with a water depth of 50 meters or less. By using a transportion means or transporter which is partly embedded in the seabed, an unintended contact between the transportion means or transporter and a vessel may be prevented in a coastal region with lower water depth. Also, an obstruction of vessel traffic by the transportion means or transporter may be avoided. The cable may be embedded in the seabed for instance by arranging it in a trench, which has been plowed in the seabed prior to the arrangement of the transportion means or transporter, or the arrangement of the second section of the transportion means or transporter, respectively.

In an embodiment, the buoyancy means or buoyancy device is a distributed buoyancy means or device that extends along at least a portion of the transportion means or transporter and/or the buoyancy means or device is a concentrated buoyancy means or device that is attached at one or more points to the transportion means or transporter. As a distributed buoyancy means, for instance a sheath, a rope or a wire of a low-density material may be used. Low density refers in this context to a material with a density lower than the density of water. The distributed buoyancy means or device may be for instance an elongated structure like a rope or wire made of nylon or another low-density material, which is wrapped along the transportion means or transporter at least in a portion of the transportion means or transporter or which is bundled with one or more transportion means or transporter in a mutual bundle. Also, a sheath made of a low-density material that surrounds at least a portion of the transportion means or transporter may be used. In particular, one or more elongated buoyancy means extending along the entire transportion means or transporter may be used.

The distributed buoyancy means or device have the advantage that they do not have the risk of leaking and thereby changing the density, as it may be the case with a buoy. Therefore, the distributed buoyancy means or device are cost efficient and reliable buoyancy means.

In addition, or alternatively, concentrated buoyancy means or device which are attached to the transportion means or transporter at one or more points may be used. A concentrated buoyancy means may comprise for instance a gas-filled cavity like a balloon, a gas-filled bell or the like. This type of buoyancy means or device may be attached to the transportion means or transporter at a single position, for instance by using an attachment means like a rope, a chain, a wire or a cable. Also, an attachment to two or more points is possible.

In an embodiment, the weight means or weight device is a distributed weight means or weight device that extends along at least a portion of the transportion means or transporter and/or the weight means or weight device is a concentrated weight means or weight device that is attached at one or more points to the transportion means or transporter. As a distributed weight means or weight device, for instance a sheath, a rope or a wire of a high-density material may be used. High density refers in this context to a material with a density higher than the density of water. The distributed weight means or weight device may be for instance a rope or wire made of steel or another high-density material, which is wrapped along the transportion means or transporter at least in a portion of the transportion means or transporter or which is bundled with one or more transportion means or transporter in a mutual bundle. Also, a sheath made of a high-density material that surrounds at least a portion of the transportion means or transporter may be used. In particular, one or more elongated weight means or weight device extending along the entire transportion means or transporter may be used.

In addition, or alternatively, concentrated weight means or weight device which are attached to the transportion means or transporter at one or more points may be used. A concentrated weight means or weight device may comprise for instance a weight element made of a high-density material like steel or concrete. The concentrated weight means or weight device may be attached to the transportion means or transporter at a single position, for instance by using an attachment means like a rope, a chain, a wire or a cable. The concentrated weight means or weight device may also be attached to the transportion means or transporter at two or more points.

It is possible that a plurality of concentrated buoyancy means and/or a plurality of concentrated weight means or weight device is attached along a transportion means or transporter, or a portion of the transportion means or transporter, by using the attachment means. In particular, the concentrated buoyancy means and/or the concentrated weight means or weight device may be attached equidistantly to the transportion means or transporter. In addition, or alternatively, a plurality of elongated buoyancy means or device and/or a plurality of elongated weight means or weight device may be attached to the transportion means or transporter so that they each extend along a portion of the transportion means or transporter, or its first section, respectively. Also, the distributed buoyancy means or device and/or the distributed weight means or weight device may be distributed equidistantly along the length of the transportion means or transporter, or its first section, respectively.

In an embodiment, the buoyancy means is arranged at the sea surface or floating below the sea surface and/or the weight means or weight device is arranged on the seabed or floating above the seabed. Concentrated buoyancy means like buoys, balloons or gas-filled cavities may be arranged floating at the sea surface or floating below the sea surface. In particular, by using a plurality of such concentrated buoyancy means spaced in a distance to each other on the transportion means or transporter, a vessel traffic in between the buoyancy means becomes possible. These buoyancy means are in particular attached using attachment means like ropes, chains, wires or cables, so that the transportion means or transporter is floating at a distance below the buoyancy means at the water surface.

It is also possible, that the buoyancy means is arranged floating in the water, and hence in a distance to the water surface. This may be the case for concentrated and/or elongated buoyancy means.

The weight means or weight device may be arranged floating above the seabed, in particular when they are used together with a floating transportion means or transporter and/or buoyancy means causing an updrift of the connection means or connector. Concentrated weight means or weight device, that comprise a weight element which is connected to the transportion means or transporter by an attachment means may also be arranged on the seabed so that the transportion means or transporter may float above the weight elements and hence above the seabed. A distributed weight means or weight device may float at the same depth as the transportion means or transporter.

It is possible that different types of buoyancy means and/or weight means or weight device and/or different types of arrangements, or positions, respectively, of the buoyancy means and/or the weight means or weight device are used along the length of the transportion means or transporter, or its first section, respectively. This allows for realizing different types of floating arrangement of the transportion means or transporter along the length of the transportion means or transporter, or its first section, respectively.

In an embodiment, the buoyancy of the buoyancy means is adjustable by at least one adjustment means. This allows for adjusting the buoyancy of the buoyancy means in such manner that the transportion means or transporter, in particular a middle section of the transportion means or transporter spanning over the majority of the distance between the two connected facilities, is arranged within a target depth range in the sea. The adjustable buoyancy of the buoyancy means can be used to adapt the density of the connection means or connector to a desired depth, or depth range, respectively.

In an embodiment, the buoyancy means comprises at least one cavity at least partially shielded from water, wherein at least one liquid and/or gaseous medium may be pumped in and/or removed from the cavity by the adjustment means for adjusting the buoyancy of the buoyancy means. Using a cavity like a balloon or partially shielded cavity like a bell, to which a gaseous medium may be pumped in and out, the density of the buoyancy means may be adjusted. Consequently, also the density of the connection arrangement may be adjusted to the depth, in which the transportion means or transporter shall flow in the water. The adjustable buoyancy of the buoyancy means can be used to lower the transportion means or transporter in the water, if the current position is too high, or to lift it up, if the current position is too deep, respectively.

In an embodiment, the connection means or connector comprises a control unit, wherein the control unit is configured to control the adjustment means in dependency of the depth information, in particular to hold at least a section of the transportion means or transporter within a predetermined depth range. This allows for an automatic adjustment of the depth, in which the transportion means or transporter, or the first section of the transportion means or transporter, respectively, floats in the water. The depth information may be transmitted to the control unit from an external communication device, or it may be determined by the connection means or connector and/or one of the facilities.

In an embodiment, the connection means or connector comprises at least one sensor for determining a depth of at least a section of the transportion means or transporter in the sea, wherein the sensing means or sensor is adapted to communicate a depth information describing the depth of the section of the transportion means or transporter to a further component of the connection means or connector, to at least one of the facilities and/or to an external communication devise.

The depth information allows to adjust the position of the transportion means or transporter when environmental influences are changing. The position of the transportion means or transporter may change for instance due to updrift effects caused by currents, tidal movements or the like. These influences may be compensated using the adjustable buoyancy means.

In addition, the depth information created by the sensing means or sensor allows for causing a warning message if the transportion means or transporter is floating not deep enough for vessels to pass by above. The sensing means or sensor may be connected for example to one or more optical fibers of the transportion means or transporter. The sensing means or sensor may comprise for instance an optical fiber time domain reflectometer for determining the bending of the optical fibers and therefore the bending of the transportion means or transporter.

From this bending, the depth of the transportion means or transporter, or the depth distribution over the length of the transportion means or transporter, respectively, may be determined. For instance, when the transportion means or transporter is floating in a depth between zero meters and 15 meters, an alarm may be sent to warn vessels in the vicinity of the transportion means or transporter and to prevent a vessel activity around the floating transportion means or transporter. For the generation of the warning, the depth information may be communicated to a further component of the connection means or connector, one of the facilities and/or to an external communication device, which may be located onshore and/or on a vessel in the vicinity of the connection arrangement.

For example, a system for tracking of an automatic indication systems (AIS) tracking the vessel position may be used to send a warning message to vessels in the vicinity of the transportation arrangement. The same system may be also used to send a warning message to vessels that have in advance set a sailing route that passes in between the two offshore facilities, or the offshore facility and the onshore facility, respectively, and hence above the transportion means or transporter.

In an embodiment, one or more weight means or weight device are attached to a central section of the transportion means or transporter and/or of the first section of the transportion means or transporter, wherein no weight means or weight device are attached outside of the central section. In particular, one single weight means or weight device may be used as a ballast unit in a central section of the transportion means or transporter. The transportion means or transporter is accordingly below the water level and comprises a bend, or curved shape, respectively. The deepest position of the transportion means or transporter will be in the central area, in which the at least one weight means or weight device is attached. In particular, a vessel traffic above the central portion of the transportion means or transporter becomes possible. The central section may be in particular the middle of the transportion means or transporter, or the middle of the first section respectively. Alternatively, the central section may be offset from the geometrical middle of the transportion means or transporter, or its first section, respectively.

In particular, both the transportion means or transporter and the weight means or weight device attached to the central section of the transportion means or transporter, or its first section, respectively, are floating in the sea. It is possible that in addition also buoyancy means, which are floating particular close to the transportion means or transporter below the sea level may be used. Alternatively, elongated buoyancy means extending along the transportion means or transporter may be used.

Such an arrangement facilitates the determination of the depth of the transportion means or transporter by a measurement of the bending of the transportion means or transporter. Since only one weight means or weight device, or a low number of weight means or weight device, is used, this type of arrangement allows for cost-efficient connection means or connector.

In an embodiment, at least one of the offshore facilities is an offshore wind turbine and/or an offshore substation connected to one or more offshore wind turbines. The offshore substation may be a hub, which is connected to a plurality of offshore wind turbines and which collects gas and/or electricity provided by the wind turbines. The offshore substation may be used for instance to invert and/or transform electrical energy transported from the wind turbines to the substation.

In addition, or alternatively, the offshore substation may be used to produce gas from electricity provided by the offshore wind turbines and/or to collect gas which is produced by the individual wind turbines and collected at the substation for being transported to the offshore substation. In particular, the offshore substation may be connected to an onshore facility, which may comprise for instance the connection to an electricity grid and/or to a gas grid. In particular, it is possible that a plurality of one or more floating wind turbines is connected to one or more floating offshore substations, wherein the one or more offshore substations are connected to one or more onshore facilities to allow for feeding the electricity and/or the gas into a power grid or a gas grid, respectively.

In a method according to embodiments of the invention for connecting two facilities with a connection means or connector comprising a transportion means or transporter, at least one buoyancy means and/or at least one weight means or weight device, wherein the transportion means or transporter is adapted for transportation of electricity and/or a fluid medium, wherein the connection means or connector is arranged in the sea and wherein the buoyancy means and/or the weight means or weight device are attached to the transportion means or transporter,
the connection means or connector is connected to an offshore facility and arranged between the offshore facility and a further offshore facility, wherein the connection means or connector is a ranged floating at a distance from the seabed over the entire or almost the entire distance between the facilities, and/or
the buoyancy means and/or the weight means or weight device are attached to a first section of the transportion means or transporter, wherein the first section of the transportion means or transporter is connected to at least one offshore facility and arranged floating at a distance from the seabed, wherein the second section of the transportion means or transporter connected to the first section and to an onshore facility is arranged embedded in the seabed.

Connecting the two facilities by the connection means or connector comprising the transportion means or transporter floating at a distance from the seabed over the entire or almost the entire distance between the facilities, or which is comprising a floating first section, respectively, an easy installation of a connection between the facilities is possible, in particular since no connection to undersea structures on the seabed or the like are required.

In an embodiment, the connection means or connector is arranged using a vessel, wherein the connection means or connector is lowered at least partly from the vessel into the sea for arranging it between the facilities. It is possible that the buoyancy means and/or the weight means or weight device are attached to the transportion means or transporter on bord on the vessel or that the connection means or connector is loaded on the vessel already comprising the attached buoyancy means and/or weight means or weight device. Both options allow for lowering the entire connection means or connector from the vessel into the sea.

Due to the density adjustment obtainable by using the buoyancy means and/or the weight means or weight device, the transportion means or transporter arranges itself at the target depth in the sea. Also, weight means or weight device, which are arranged on the seabed, may be lowered from a vessel as they sink to the seabed automatically.

A simple vessel like a platform supply vessel (PSV) may be used for installation of the connection means or connector. In an embodiment, a vessel with a digital position (DP) system is used to facilitate the arrangement of the connection means or connector at the target positions, or along a target course, respectively.

In an embodiment, the transportion means or transporter comprises an outer shell and at least one inner pipe and/or at least one inner cable, wherein the buoyancy means and/or the weight means or weight device are attached to the outer shell, wherein the outer shell is arranged between the facilities prior to an arrangement of the inner pipe and/or the inner cable in the outer shell. This allows for partial arranging of the connection means or connector by lowering the outer shell from a vessel. After installation of the outer shell and/or the buoyancy means and/or the weight means or weight device attached to the outer shell in between the two facilities, the inner pipe and/or the inner cable of the transportion means or transporter may be pulled or pushed through the outer shell. The outer shell may be for instance a pipe or a tube which protects the inner pipe and/or the cable of the transportation arrangement.

### BRIEF DESCRIPTION

Some of the embodiments will be described in detail, with reference to the following figures, wherein like designations denote like members, wherein:

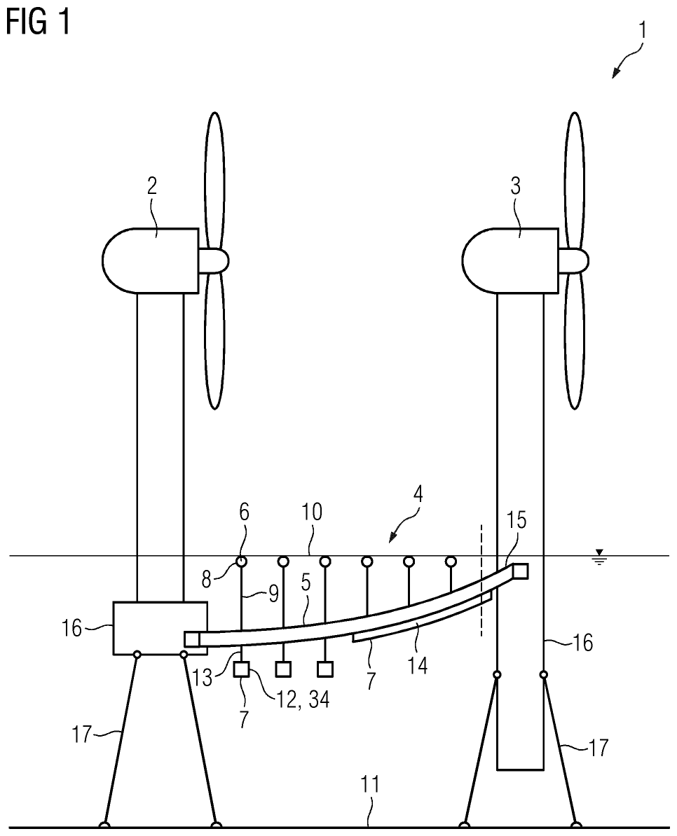

FIG. 1 shows a first embodiment of a facility arrangement;

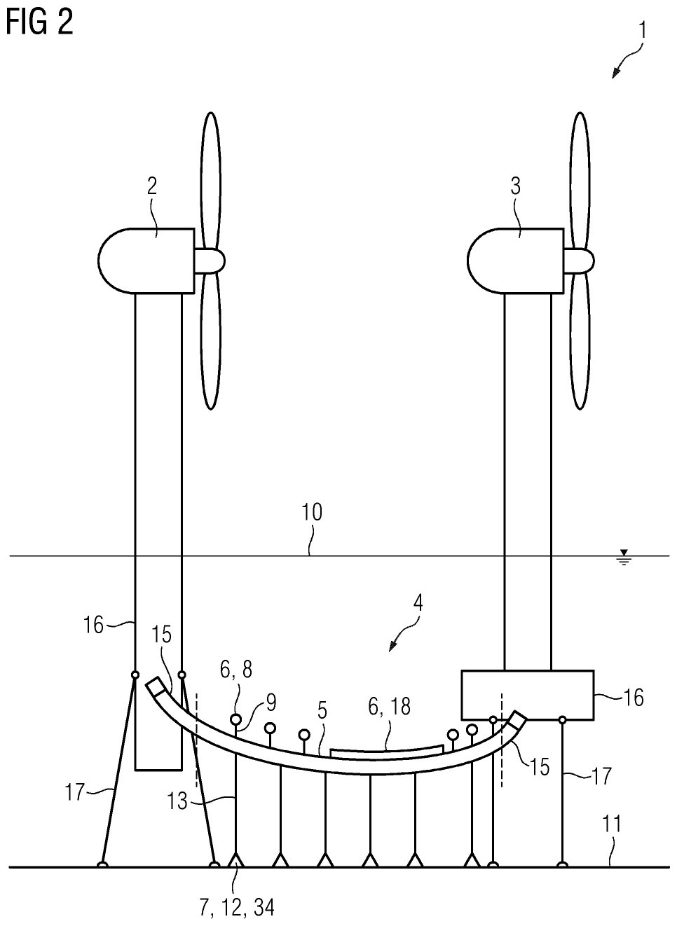

FIG. 2 shows a second embodiment of a facility arrangement;

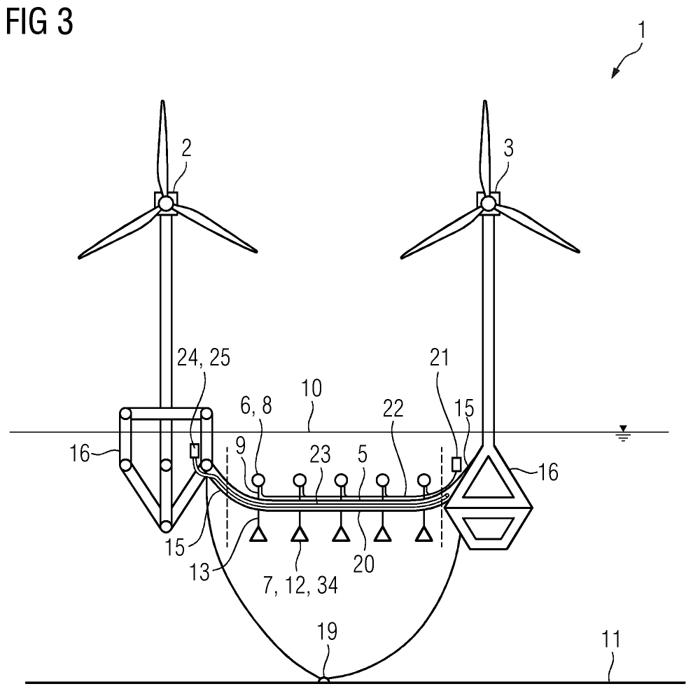

FIG. 3 shows a third embodiment of a facility arrangement;

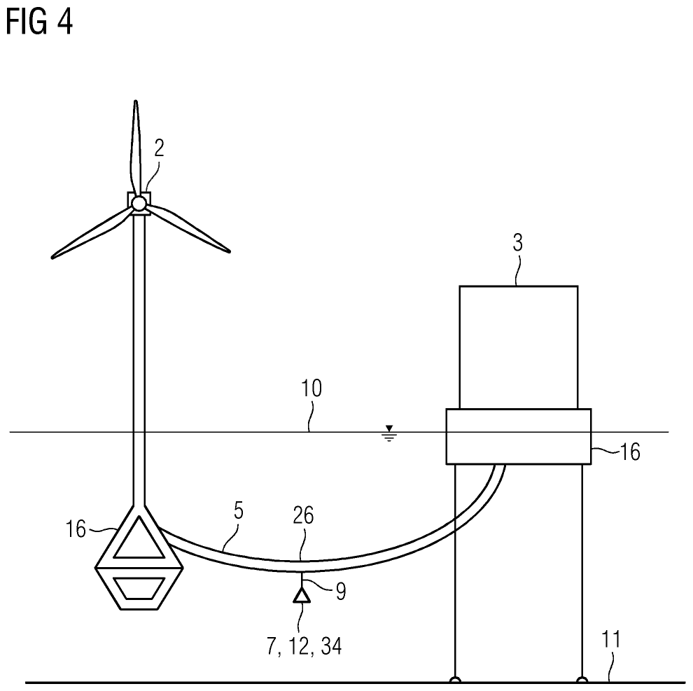

FIG. 4 shows a fourth embodiment of a facility arrangement;

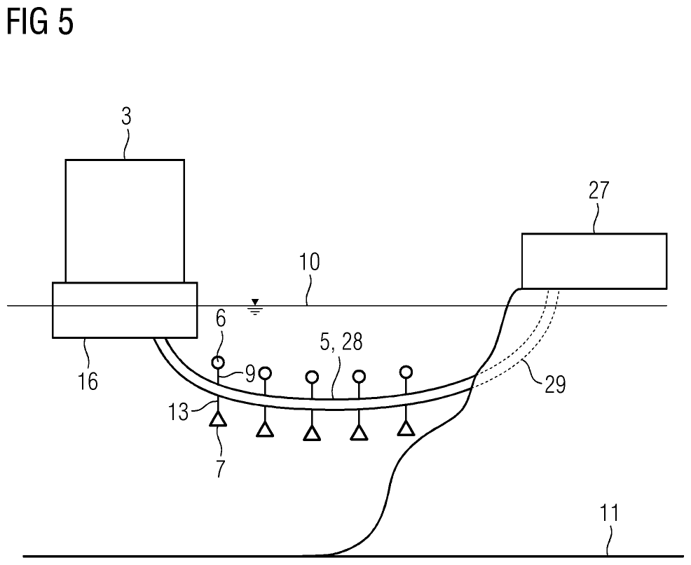

FIG. 5 shows a fifth embodiment of a facility arrangement;

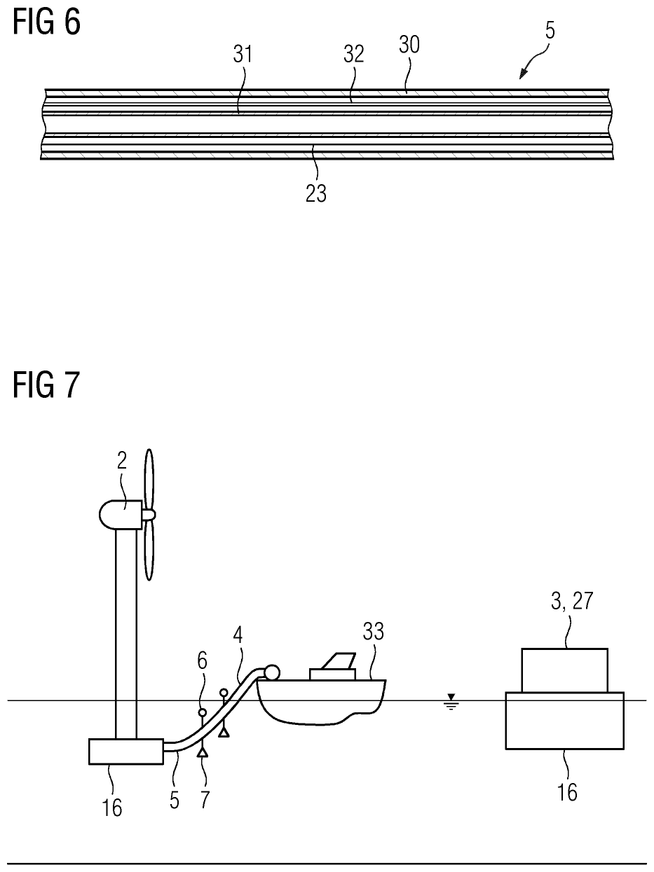

FIG. 6 shows a detailed view of a connection means or connector for an embodiment of a facility arrangement; and

FIG. 7 shows a schematic depiction of connecting two facilities for describing an embodiment of a method for connecting at least two facilities.

### DETAILED DESCRIPTION

In FIG. 1, a first embodiment of a facility arrangement 1 is shown. The facility arrangement 1 comprises two offshore facilities 2, 3 and a connection means or connector 4. In this embodiment, the offshore facilities 2, 3 are floating offshore wind turbines.

The connection means or connector 4 comprises a transportion means or transporter 5, a plurality of buoyancy means or device 6 and a plurality of weight means or weight device 7. The transportion means or transporter 5 is adapted for transportation of electricity and/or for transportation of a fluid medium. The buoyancy means or device 6 and the weight means or weight device 7 are attached to the transportion means or transporter 5.

The transportion means or transporter 5 is used to connect the two facilities 2, 3. The transportion means or transporter 5 may comprise at least one electrical cable, at least one optical cable and/or at least one pipe for gas transport. The electrical cable may be for instance an armoured sea cable or an unarmoured terrestrial cable, which is arranged in a pipe, wherein the pipe serves as a protection shell for the cable. In addition, or alternatively, the pipe may be used for gas transport. The transportion means or transporter 5 may also comprise a plurality of cables and/or pipes allowing transportation of both electrical energy and gas.

The transportion means or transporter 5 is used to electrically connect the two facilities 2, 3 to each other, to slow for communication between the facilities 2, 3 and/or to allow for transportation of a fluid medium between the facilities 2, 3. It is in particular possible, that one or both of the facilities 2, 3 are connected to further facilities of the facility arrangement 1 by using further connection means or connector 5.

The buoyancy means 6 and the weight means or weight device 7 attached to the transportion means or transporter 5 allow for adjusting the density of the connection means or connector arrangement 4 and therefore to adapt the position of the transportion means or transporter 5 in the sea. Depending on the type of the transportion means or transporter 5, it is possible that only buoyancy means 6 or only weight means or weight device 7 are used. In particular a transportion means or transporter comprising one or more electrical cables for transportation of electrical energy may have a considerable weight so that additional weight means or weight device for obtaining the floating arrangement of the transportion means or transporter 5 are not required. In this case, only buoyancy means 6 may be used.

Contrary, a transportion means or transporter 5 which is used for transportation of a gas like hydrogen, ammonium, methane or another type of gas may have a density which is below the density of water, so that only one or more weight means or weight device 7 may be used for obtaining the floating arrangement of the transportion means or transporter 5.

In this embodiment, the buoyancy means 6 are provided as concentrated buoyancy means 8, which are provided as buoys each attached to the transportion means or transporter 5 at one or more points using an attachment means 9. The buoyancy means 6 are arranged at the sea surface 10, wherein the transportion means or transporter 5 is arranged below the sea surface 10, but above a seabed 11. The buoyancy means 6 at the sea surface 10 may be spaced apart equidistantly or with varying distances, in particular with sufficient distances for a vessel to pass by in between the buoys. The buoys at the sea surface 10 indicate the position of the transportion means or transporter 5 in the water. The concentrated buoyancy means 8 are in particular chosen in such manner that they stay at the sea surface 10 in calm weather conditions and that they do not follow the movement of the sea in high wind and/or high wave weather conditions to reduce the movements inflicted on the transportion means or transporter 5. This has the advantage that the transportion means or transporter 5 is protected from wave movement. When there are big waves in the vicinity of the transportion means or transporter 5, it will stay relative in the sea level area, because the concentrated buoyancy means 8 can be designed with limited uplift that allows them to be submerged locally in the wave.

The weight means or weight device 7 are be provided as concentrated weight means or weight device 12 each comprising a weight element 34, which is attached to the transportion means or transporter 5 at one or more points using an attachment means 13. The weight elements 34 may consist for instance of metal, concrete or another high-density material which has a density exceeding the density of water.

In addition, or alternatively, one or more elongated weight means or weight device 14 extending at least partially along the length of the transportion means or transporter 5 may be used. A distributed weight means or weight device 14 may be for instance a steel rope or a steel sheath, which is attached to the transportion means or transporter 5 for increasing its weight, or density, respectively. It is possible that only one or more distributed weight means or weight device 14 are used, that only concentrated weight means or weight device 12 are used, and/or that a combination of concentrated weight means or weight device 12 and elongated weight means or weight device 14 is used.

The attachment means 9 for attaching the buoyancy means 6 to the transportion means or transporter 5 may be cables, chains, ropes, or wires, in particular of a low-density material. The attachment means 13 of the weight means or weight device 7 may also be cables, chains, ropes, or wires, in particular with a density that is higher than water. The density of the plurality of buoyancy means 6 and the density of the plurality of weight means or weight device 7 may be adapted to allow for an arrangement of the connection means or connector 4 within a target depth range in the sea under consideration of the density of the transportion means or transporter 5 and/or the densities of the attachment means 9, 13.

In particular, the transportion means or transporter 5 is arranged below the sea surface 10, in particular in a depth of 10 m to 40 m or more. In particular, a part of the transportion means or transporter 5 outside of connection areas 15 in the immediate proximity of the facilities 2, 3 is arranged in a depth of ten meters and more. The depth of the connection areas 15 in the sea, or their minimum distance from the sea surface 10, respectively, may depend on the type of the foundation 16 of the facility 2, 3, to which the transportion means or transporter 5 is attached.

The connection means or connector 4 is connected to the floating foundations 16 of the offshore facility 2, 3. The connection means or connector 4 may be attached to different types of floating connections 16 used for floating arrangement of offshore facilities like offshore wind turbines. The floating foundation 16 are in particular moored to the seabed 11 using a mooring arrangement 17.

The mooring arrangement 17 limits the movement of the floating foundations 16, or of the facilities 2, 3, respectively, on the water surface 10. This limits the loads and forces which act on the transportion means or transporter 5 arranged in between the facilities 2, 3. Furthermore, also the usage of the buoyancy means 6 and/or the weight means or weight device 7 stabilises the arrangement of the transportion means or transporter 5 in the sea. This allows for using a transportion means or transporter 5 with a comparably low flexibility as part of the connection means or connector 4. This reduces the need for material and/or the costs of the realization of the transportion means or transporter 5, or the connection means or connector 4, respectively.

In FIG. 2, a second embodiment of a facility arrangement 1 is shown. In this embodiment, the transportion means or transporter 5 may be for instance a pipe for hydrogen transport made of HDPE (High Density Polyethylene) and the weight means or weight device 7 are provided as concentrated weight means or weight device 12, which comprise each a weight element 34 arranged on the seabed 11. The weight elements 34 form anchors attaching the transportion means or transporter 5 on the seabed 11 and therefore stabilizing the position of the transportion means or transporter 5 in the sea.

Prior to an installation of the connection means or connector 4, the depth is surveyed, for instance by the laying vessel, and the length of each attachment means 13 is adjusted so that the transportion means or transporter is more or less at the same water depth over the entire distance between the facilities, or over almost the entire distance except in the connection areas 15.

For example, in a water depth of 300 m, the attachment means 13 between the weight elements 34 and the transportion means or transporter 5 can be around 260 meters to position the transportion means or transporter in the target depth zone which can be for instance between a depth of 10 m to 40 m form the water surface 10. Depending on the conditions of environment in the vicinity of the facilities, also a positioning between the sea surface and larger depth, for example of 100 m or more, is possible.

The connection means or connector 4 comprises a plurality of buoyancy means or device 6, which are provided as concentrated buoyancy elements 8, in particular as buoys, gas-filled bells, balloons or the like. In addition, a distributed buoyancy element 18 is used. The distributed buoyancy element 18 extends along a section of the transportion means or transporter 5. The distributed buoyancy means 18 may be for instance a cable or a rope of a material with a density lower than water, or a low-density wrapping or shell of the transportion means or transporter 5, respectively. It is possible that the distributed buoyancy element 18 extends over almost the entire length of the transportion means or transporter 5. In this case, the buoyancy elements 8 may be omitted.

Alternatively, it is also possible to omit the distributed buoyancy element 18 and to use only concentrated buoyancy elements 8, in particular each attached by using one or more attachment means 9. In this embodiment, the buoyancy means 6 are arranged below the sea surface 10. This allows for creating a path in between the facilities 2, 8 which may be passed by a vessel. Due to the floating arrangement of the transportion means or transporter 5 in the sea, in particular in a depth of 10 m, 15 m or more from the sea surface 10, a contact between the vessel, in particular the propeller of the vessel, and the transportion means or transporter 5 or other components of the connection means or connector 4, may be avoided.

In FIG. 3, a third embodiment of a facility arrangement 1 is shown. In this embodiment, the floating foundation 16 of the offshore facilities 2, 3 are attached using a mutual anchor point 19. The buoyancy means 6 and the weight means or weight device 7 are arranged both floating in water, so that both the buoyancy means 6 and the weight means or weight device 7 are arranged at a distance to the sea surface 10 and at a distance to the seabed 11.

Outside of the connection areas 15, in which the connection means or connector 4 is connected to the offshore facilities 2, 3, or their floating foundations 16, respectively, the transportion means or transporter 5 comprises a straight middle section 20. A straight middle section 20 may be beneficial for transportion means or transporter 5 comprising at least one electrical cable since due to the reduced bending radii in this arrangement.

In particular, the straight middle section 20 may be arranged at a depth of 10 meters or more below the sea surface 10. For instance, the transportion means or transporter 5 may be arranged at a depth of 15 meters. In areas of a deep water with a depth of several 100 meters, also a deeper positioning of the transportion means or transporter 5, or its middle section 20, respectively is possible. This may occur for instance if in some areas currents or tidal movement are present and therefore comparatively high loads are acting on the transportion means or transporter 5 so that a deeper positioning becomes beneficial.

In this embodiment, the buoyancy means 6, which are provided as buoyancy elements 8, are adjustable and connected to an adjustment means 21, for instance by a pipe arrangement 22. By the adjustment means 21, the buoyancy of the buoyancy means 6 may be adjusted to adjust a density of the connection means or connector and therefore the depth of the transportion means or transporter 5 in the water. The adjustment means 21 may be a part of the connection means or connector 4 or a part of one of the facilities 2, 3.

The buoyancy means or device 6 comprise each at least one cavity, which is at least partially shielded from the water. By the adjustment means 21, at least one liquid medium and/or at least one gaseous medium may be pumped in and a removed from the cavity of the buoyancy means or device for adjusting the buoyancy of the buoyancy means or device 6. The buoyancy means 6 may be provided for instance as balloons or as bells, to which water or air may be added, or from which the water and/or the air may be removed, respectively.

In addition, the connection means or connector 4 comprises a sensing means or sensor 23 for determining a depth of at least a section of the transportion means or transporter 5 in the sea. The sensing means or sensor 23 is adapted to communicate a depth information describing the depth of the transportion means or transporter 5, or the depth of a section of the transportion means or transporter 5, respectively, to a further component 24 of the facility arrangement 1. The further component 24 may be for instance a control unit 25.

The sensing means or sensor 23 may comprise for instance an optical time domain reflectometer, which is connected to an optical cable of the transportion means or transporter. The sensing means or sensor 23 is adapted to measure a curvature of the transportion means or transporter 5 and therefore enables the determination of a depth of the transportion means or transporter 5, or of a section of the transportion means or transporter 5, for instance of the middle section 20, respectively.

By the control unit 25, the adjustment means 21 may be controlled in dependency of the depth information obtain using the sensing device or sensor 23. In particular, the control unit 25 may control the adjustment means to hold the transportion means or transporter 5, or at least the middle section 20 of the transportion means or transporter 5, within a predetermined depth range.

In addition, the depth information obtained by using the sensing means or sensor 23 may be communicated from the control unit 25 to the facilities 2, 3 and/or to an external communication device. When the depth information obtained by the sensing means or sensor 23 describes a depth of the transportion means or transporter 5 which is too shallow, a warning may be generated and sent to vessels in the vicinity of the facilities 2, 3 in order to prevent them from unintendedly contacting and/or damaging the transportion means or transporter 5. Although commercial vessel traffic may be prohibited in between the wind turbines of a wind park, vessel traffic may occur for instance due to repair procedures, supply procedures or the like.

For transmitting the warning, an automatic indication system may be used for tracking the data of vessels in the vicinity of the facilities 2, 3. This enables to send a message to vessels in the area of the offshore facilities 2, 3 and/or to vessels which have a targeted root near the facilities 2, 3 and/or in particular above the transportion means or transporter 5 that exhibits two shallow depths.

The usage of the adjustable buoyancy means 6 and/or the sensing means or sensor 23 is in particular advantageous if both the buoyancy means 6 and the weight means or weight device 7 are floating in the water below the sea surface 10 and above the seabed 11, since in such an arrangement, the transportion means or transporter 5 may exhibit more movement and therefore a less stable or varying floating position in the sea. Nevertheless, the adjustable buoyancy means 6 as well as the adjustment means 21, the sensing means or sensor 23 and/or the control unit 25 may also be used separately from each other and/or in the other embodiments of the facility arrangement 1.

As an alternative, it is possible that no buoyancy means 6 are used and that the floating arrangement of the transportion means or transporter 5 is obtained by using only a distributed weight means or weight device 14 attached to a transportion means or transporter 5 that comprises one or more gas-filled pipes. The connection means or connector 4 may be realized in this case with a pipe, or tube, respectively, consisting of plastic material, for instance HDPE, as transportion means or transporter 4 comprising an outer surface of a heavier material as elongated weight means or weight device 14 to add weight to the transportion means or transporter 5. Also, in this case a density equal to or slightly larger than the surrounding sea water may be obtained.

In FIG. 4, a fourth embodiment of a facility arrangement 1 is shown. In this embodiment, the facility 3 is provided as a floating or as a bottom fixed offshore substation which works as a hub connecting in particular a plurality of offshore wind turbines.

The offshore substation may invert and/or transform electrical energy, which is transferred from one or more offshore wind turbines to the offshore substation using transportion means or transporter 5. It is also possible that the offshore substation produces gas from the electricity provided by the offshore wind turbines. The offshore substation may be connected for instance to an onshore facility to allow for feeding in gas and/or electricity provided by the facility arrangement 1 into a power grid, or a gas grid, respectively.

In this embodiment, one weight means or weight device 7 is attached to a central section 26 of the transportion means or transporter 5 to create a U-shaped bending of the transportion means or transporter 5 and therefore a path above the transportion means or transporter 5 which may be passed by vessels. Outside of the central section, in particular no further weight means or weight device 7 are arranged. Such an arrangement may be used for instance with a transportion means or transporter 5 that comprises one or more gas pipes and/or to create a comparatively deep sailing path above the transportion means or transporter 5 for vessel traffic. The central section may extend around the middle of the transportion means or transporter 5. The length of the central section may be 1% or less of the total length of the transportion means or transporter 5. It is also possible to use a central section which is arranged offset from a geometrical middle of the transportion means or transporter 5.

The weight means or weight device 7 is provided as a concentrated weight means or weight device 12 floating above the seabed 11. Alternatively, also a distributed weight means or weight device 14 and/or a concentrated weight means or weight device 12 arranged on the seabed 11 may be used. It is also possible that more than one weight means or weight device 7 are arranged at the central section 26 of the transportion means or transporter 5. In addition, also one or more concentrated buoyancy means 8 and/or one or more distributed buoyancy means 18 may be attached to the transportion means or transporter 5 as described in relation to the other embodiments.

In FIG. 5, a fifth embodiment of a facility arrangement 1 according to the invention is shown. In this embodiment, an offshore facility 3, which is provided as an offshore substation, is connected to an onshore facility 27. The transportion means or transporter 5 comprises a first section 28, which is arranged floating at a distance from the seabed 11. Furthermore, the connection means or connector 5 comprises a second section 29, which is arranged embedded in the seabed 11. The second section 29 is connected to the onshore facility 27 and to the first section 29 of the transportion means or transporter 5. In particular, the transportion means or transporter 5 may be provided as at least one one-piece cable and/or at least one one-piece pipe, which is embedded with its second section 29 in the seabed 11.

For the floating arrangement of the first section 28 of the transportion means or transporter 9, an arrangement of buoyancy means 6 and/or weight means or weight device 7 according to one of the aforementioned embodiments may be used. As an example, an arrangement of buoyancy means 6 and weight means or weight device 7 according to the second embodiment are shown. However, the buoyancy means 6 and/or the weight means or weight device 7 may also be arranged according to another embodiment. It is also possible that for different segments of the first section 28, different types of arrangements of the buoyancy means 6 and 7 or the weight means or weight device 7 are used, so that the course of the first section 28 of the transportion means or transporter 5 may be adapted to the underwater surroundings.

The second section 29 of the transportion means or transporter 5 may be embedded in the seabed 11 for instance by arranging it in a trench plowed in the seabed. After arrangement of the transportion means or transporter 5, the trench may be closed. The second section 29 is embedded in a coastal region, in particular in a depth of 50 meters or less. Depending on the position of the offshore facility 3 and/or further offshore facilities connected to the offshore facility 3, the length of the first section and/or the length of the second section may be in the range of several hundreds of meters and tens of kilometers.

In FIG. 6, an embodiment of the transportion means or transporter 5 is shown. In this embodiment, the transportion means or transporter 5 comprises an outer shell 30, in which an inner pipe 31 and inner cable 32 are arranged. Furthermore, a sensing means or sensor 23 is also arranged in the outer shell. Alternatively, the usage of a bundle of a plurality of electrical cables 32 and/or pipes 31 without an outer shell 30 as transport arrangement 5 is possible.

In FIG. 7, a method for connecting two facilities 2, 3 using a connection means or connector 4 is depicted schematically. The connection means or connector 4 is arranged in between the facilities 2, 3. The facility 3 may be an offshore facility or an onshore facility. The facility 2 is an offshore facility, in particular a floating offshore wind turbine. The connection means or connector 4 is arranged in between the facilities 2, 3 using a vessel 33. The vessel 33 may be a platform supply a vessel, from which the connection means or connector 4 is lowered in the sea. The buoyancy means 6 and the weight element 7 of the connection means or connector 4 may be attached to the transportion means or transporter 5 on bord of the vessel 33 and/or prior to loading the connection means or connector 4 onto the vessel, so that the transport arrangement 5 will arrange floating in the sea in between the facilities 2, 3.

Alternatively, when a transportion means or transporter 5 with an outer shell 30 is used, the outer shell 30 may be lowered from the vessel 33. Also in this case, the buoyancy means 6 and/or the weight means or weight device 7 may be attached to the outer shell 30 on the vessel 33. Alternatively, the outer shell 30 may be provided on the vessel 33 already with the buoyancy means 6 and/or the weight means or weight device 7 attached to it.

After arranging the outer shell 30 in between the facilities 2, 3 the inner pipe 31 and/or the inner cable 32 may be pushed and/or pulled through the outer shell 30. The outer shell 30 may be for instance a hollow pipe so that the inner pipe 31 and/or the inner cable 32 may be arranged inside it to allow for transportation of electricity and/or a fluid medium in between the facilities 2, 3.

The different embodiments of the facility arrangement 1 may be used in different water depths. In particular, the connection means or connector 4 may be attached to different types of floating foundation 16 of wind turbines 2 and/or to connect offshore wind turbines comprising different types of floating foundation 16, as schematically depicted by the different types of floating foundations 16 in the FIGS. 1-4.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A facility arrangement comprising two or more facilities and at least one connector connected to the facilities, wherein at least one of the offshore facilities is an offshore wind turbine and/or an offshore substation connected to one or more offshore wind turbines, wherein the connector comprises a transporter and at least one weight devices, wherein the transporter is configured for transportation of electricity and/or a fluid medium and/or is used for communication between the facilities and/or further communication devices by at least one optical cable, wherein the weight device is attached to the transporter,
wherein the connector is arranged between two offshore facilities, wherein the transporter is floating at a distance from the seabed over the entire or almost the entire distance between the facilities, and/or
wherein the weight device is attached to a first section of the transporter, wherein the first section is connected to at least one offshore facility and arranged floating at a distance from the seabed, wherein a second section of the transporter connected to the first section and an onshore facility is embedded in the seabed.

2. The facility arrangement according to claim 1, wherein the transporter comprises at least one electrical cable, at least one optical cable and/or at least one pipe for gas transport.

3. The facility arrangement according to claim 1, wherein the connector is connected to a floating foundation, in particular a floating foundation moored to the seabed, of the offshore facility or the offshore facilities.

4. The facility arrangement according claim 1, wherein the transporter is arranged at least partly below the sea surface and/or that the second section of the transporter is embedded in a coastal region.

5. The facility arrangement according to claim 1, wherein the weight device is a distributed weight device that extends along at least a portion of the transporter and/or that the weight device is a concentrated weight device that is attached at one or more points to the transporter.

6. The facility arrangement according to claim 1, wherein the weight device is arranged on the seabed or floating above the seabed.

7. The facility arrangement according to claim 1, wherein the connector comprises at least one buoyancy device which is attached to the transporter, wherein the buoyancy device is particularly arranged at the sea surface or floating below the sea surface.

8. The facility arrangement according to claim 7, wherein the transporter comprises the first section and the second section, wherein the buoyancy device is attached to the first section of the transporter.

9. The facility arrangement according to claim 7, wherein the buoyancy device is a distributed buoyancy device that extends along at least a portion of the transporter and/or that the buoyancy device is a concentrated buoyancy device that is attached at one or more points to the transporter.

10. The facility arrangement according to claim 7, wherein the buoyancy of the buoyancy device is adjustable by at least one adjustment.

11. The facility arrangement according to claim 10, wherein the buoyancy device comprises at least one cavity at least partially shielded from water, wherein at least one liquid and/or gaseous medium may be pumped in and/or removed from the cavity by the adjustment device for adjusting the buoyancy of the buoyancy device.

12. The facility arrangement according to claim 10, wherein the facility arrangement comprises a control unit, wherein the control unit is configured to control the adjustment device in dependency of the depth information, to hold at least the section of the transporter within a predetermined depth range.

13. The facility arrangement according to claim 1, wherein the connector comprises at least one sensor for determining a depth of at least a section of the transporter in the sea, wherein the sensor is configured to communicate a depth information describing the depth of at least the section of the transporter to a further component of the facility arrangement, to at least one of the facilities and/or to an external communication device.

14. The facility arrangement according to claim 1, wherein one or more weight device are attached to a central section of the transporter and/or of the first section of the transporter, wherein no weight device are attached outside of the central section.

15. A method for connecting two facilities with a connector comprising a transporter and at least one weight device, wherein at least one of the offshore facilities is an offshore wind turbine and/or an offshore substation connected to one or more offshore wind turbines, wherein the transporter is configured for transportation of electricity and/or a fluid medium and/or is used for communication between the facilities and/or further communication devices by at least one optical cable, wherein the transporter is arranged in the sea and wherein the weight device is attached to the transporter,
wherein the connector is connected to an offshore facility and arranged between the offshore facility and a further offshore facility, wherein the transporter is arranged floating at a distance from the seabed over the entire or almost the entire distance between the facilities, and/or
wherein the weight device is attached to a first section of the transporter, wherein the first section is connected to at least one offshore facility and arranged floating at a distance from the seabed, wherein a second section of the transporter connected to the first section and to an onshore facility is arranged embedded in the seabed.
